(19) United States
(12) Patent Application Publication
(10) Pub. No.: US 2010/0212175 A1
(43) Pub. Date: Aug. 26, 2010

(54) Tape measure with speed control

(76) Inventor: Young Joon Choi, Oakland, NJ (US)

Correspondence Address: RICHARD E. NOVAK, CHESTNUT HILL PROFESSIONAL CENTER, 157 ENGLE STREET, ENGLEWOOD, NJ, 07631, US

(21) Appl. No.: 12/380,086

(22) Filed: Feb. 24, 2009

(51) Int. Cl. G01B 3/10

(52) U.S. Cl. 33/761

(57) ABSTRACT

A tape measure is disclosed which includes speed control device which allows the user to control the speed at which the extended tape is retracted into the housing. The housing defines a chamber and has a peripheral wall with a slot-shaped opening. A coiled tape blade within the housing is attached at it's interior end to a spring which allows automatic retraction of the tape into the housing. The speed control device is attached to the outside of the housing above the slot shaped opening. Another opening in the housing exposes the tape so that a roller controlled by pressure from the speed control device will make contact with the tape in the event the user exerts pressure on the device. Said device is unaffected by various environmental conditions such as saw dust, particulate contamination or moisture. A handle is attached to the rear end of the housing, opposite to the speed control device, to facilitate manipulation and use of the tape measure.

### FIELD OF THE INVENTION

The present invention relates to the field of tape measures. More particularly, this invention relates to a device that will allow the user to control the speed of retraction of measuring tape into the housing.

### BACKGROUND OF THE INVENTION

Tape measures are widely used portable devices for taking measurements. Generally a tape measure consists of a housing, and within that housing contains a coiled tape connected at its inner end to a spring, and having a tab attached at the outer end of the tape. Prior art tape measures give the user little or no control over the speed the tape is extended from the housing or is retracted into the housing. When the tape is extended for any distance outside the housing, the retracting tape may reach such a speed as to bend, whip and snap around the user's hand and the surface being measured. This lack of control has potential to fatigue and damage the tape over time, and may also have the potential to damage the measured surface or the user's hand.

Devices which attempt to overcome these disadvantages have been developed in the past, but have not been completely successful. Devices such as those disclosed by U.S. Pat. No. 6,595,451 address these concerns by providing a locking device. These patents, however, present difficulties in that they provide improvement in this regard but do not control the speed of tape retraction but only allow the tape to stop and go.

An improved device is needed which is specifically designed to allow the user to control the speed of the retracting tape. Such a device should be easy to manipulate and should allow the user to control the speed of the retracting tape from allowing the tape to retract at full speed through a range of speeds to a very slow speed and to allow the user to temporarily stop the tape retraction. Such control will yield a tape measure which is much more useful than the tape measures available in the prior art. The device should be unaffected by environmental conditions, such as saw dust, particulate contamination or moisture. Moreover, attaching a handle to the back of the tape measure housing will allow more comfortable manipulation and easier use of a tape measure.

### SUMMARY OF THE INVENTION

It is therefore an object of the present invention to provide a new and improved tape measure which allows the user to control the speed of the retracting tape into the housing by providing a lever mechanism which allows the user to press a control surface which further presses a roller into contact with the tape through an opening in the housing. Pressure of the roller on the housing slows the speed of retraction of the tape to the speed desired by the user.

It is a further object of the present invention to provide a new and improved tape measure which allows the user to control the speed of the retracting tape into the housing by incorporating a device which is unaffected by various environmental conditions such as saw dust, particulate contamination or moisture.

It is a further object of the present invention to provide a new and improved tape measure which includes a handle to allow the user to more comfortably and easily manipulate the tape measure.

These and other features of the invention can be further understood by reference to the following drawings.

### BRIEF DESCRIPTION OF THE DRAWINGS

FIG. 1 shows a first embodiment of the tape measure, showing a handle and a speed control button.

FIG. 2 shows a first embodiment of the tape measure with the housing partially removed to illustrate the coiled tape within and the user applying pressure to the speed control button.

FIG. 3 shows a second embodiment of the tape measure, showing the speed control button with the roller in contact with the tape.

FIG. 4 shows a second embodiment of the tape measure with the housing partially removed to illustrate the coiled tape within and pressure on the speed control button bringing the roller into contact with the tape.

FIG. 5 shows a second embodiment of the tape measure, showing the user's finger pressure on the speed control button bringing the roller in contact with the tape.

FIG. 6 shows a first embodiment of the tape measure, showing the user's finger pressure on the speed control button bringing the roller in contact with the tape.

### DETAILED DESCRIPTION OF THE INVENTION

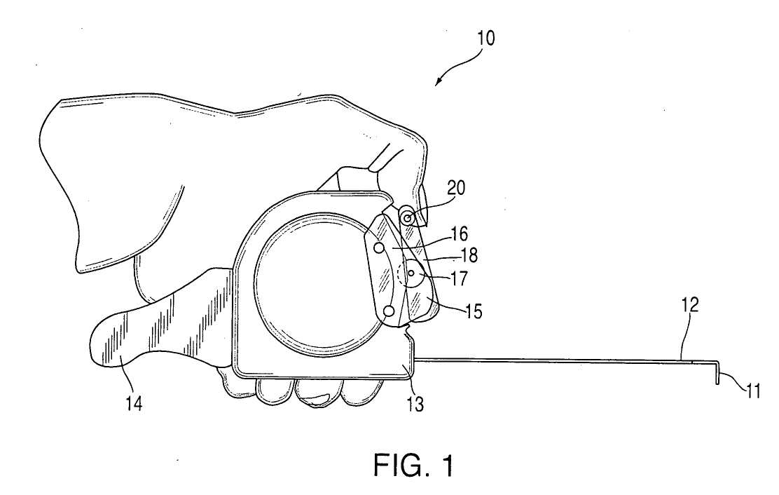

In FIG. 1, the first embodiment of the invention 10 is illustrated with the tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of lucite pieces 15 and 16 joined by pin 17 to two more Lucite pieces 18 and 18 joined by a member 17. Pressure of the user's finger presses roller 20 against tape 12 to allow variable control of the rate of speed of the retracting tape 12.

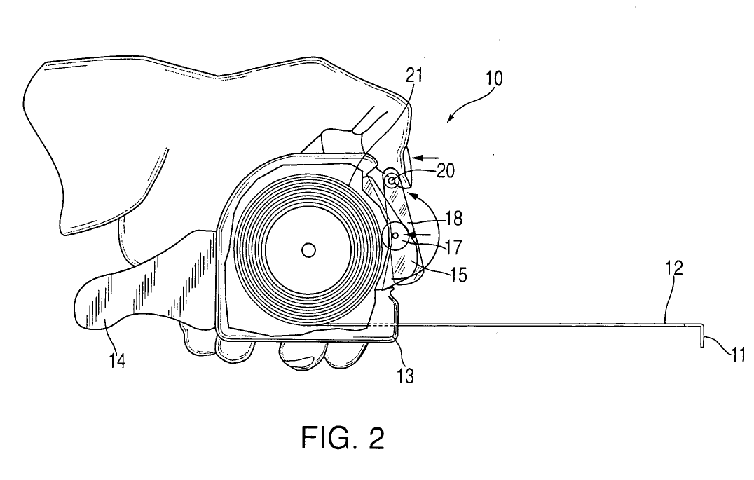

In FIG. 2, the first embodiment of the invention 10 is illustrated with one wall of the housing 13 removed to illustrate the interior of the tape measure 10. Tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of Lucite pieces 15 and 16 joined by-pin 17 to two more lucite pieces 18 and 18 joined by a member 17. Pressure of the user's finger presses roller 20 against tape 12 to allow variable control of the rate of speed of the retracting tape 12.

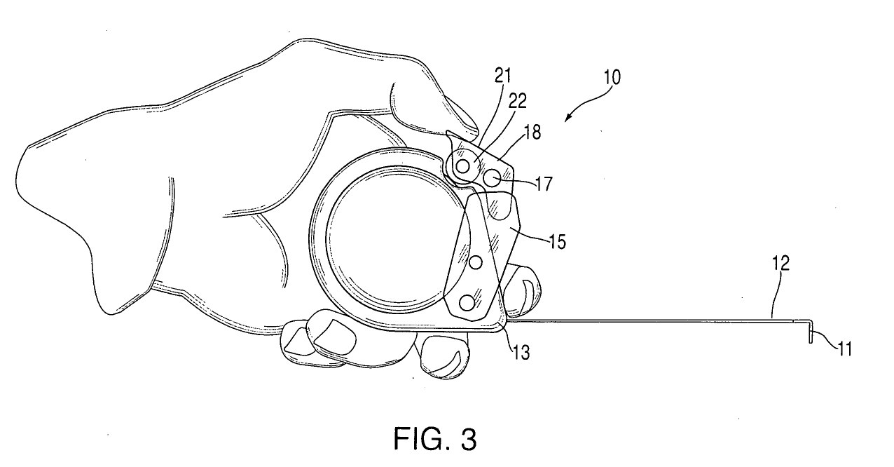

In FIG. 3, the second embodiment of the invention 10 is illustrated with one wall of the housing 13 removed to illustrate the interior of the tape measure 10. Tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of Lucite pieces 15 and 16 joined by pin 17 to two more Lucite pieces 18 and 18 joined by a member 17. Pressure of the user's finger presses roller 20 against tape 12 to allow variable control of the rate of speed of the retracting tape 12.

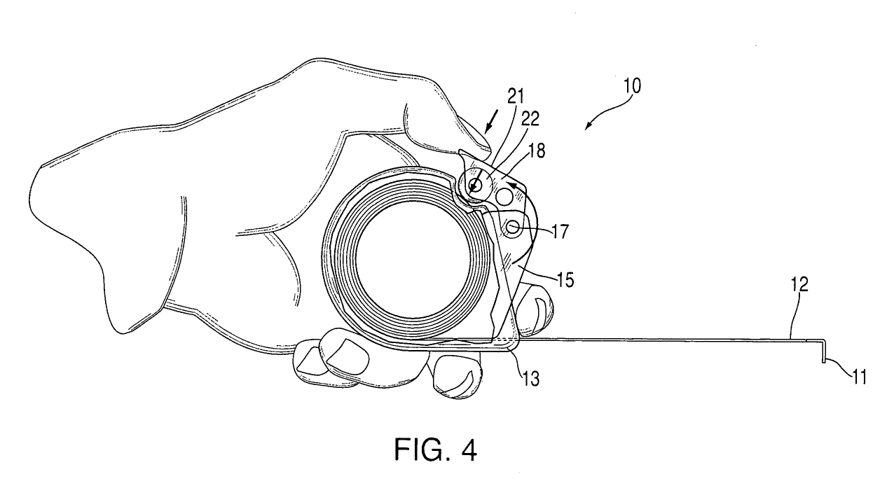

In FIG. 4, the second embodiment of the invention 10 is illustrated with one wall of the housing 13 removed to illustrate the interior of the tape measure 10. Tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of Lucite pieces 15 and 16 joined by pin 17 to two more Lucite pieces 18 and 18 joined by a member 17. Pressure of the user's finger presses roller 20 against tape 12 to allow variable control of the rate of speed of the retracting tape 12.

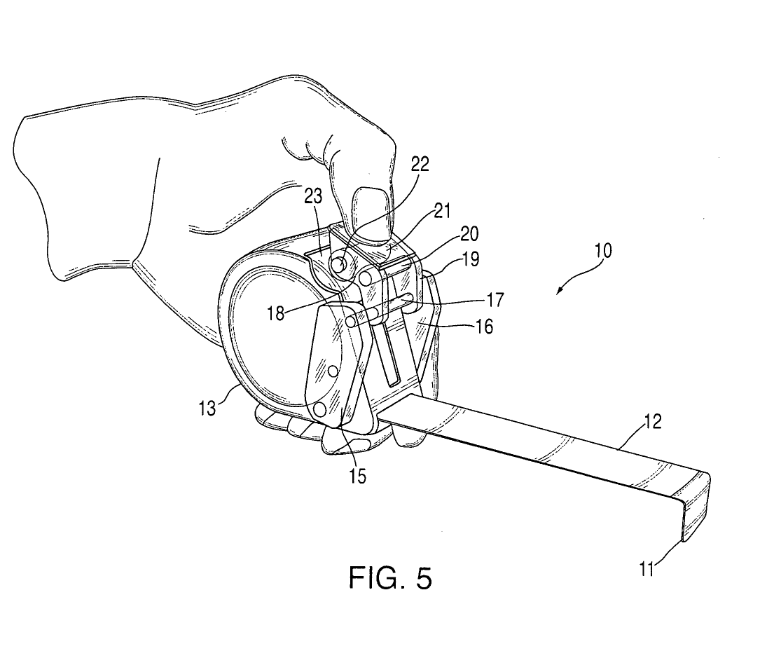

In FIG. 5, the second embodiment of the invention 10 is illustrated tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of Lucite pieces 15 and 16 joined by pin 17 to two more Lucite pieces 18 and 18 joined by a member 17. Pressure of the user's finger presses roller 20 against tape 12 to allow variable control of the rate of speed of the retracting tape 12.

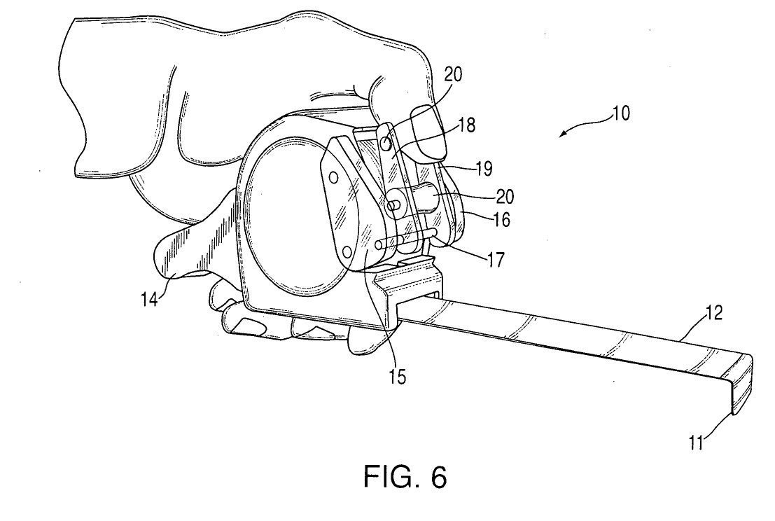

In FIG. 6, the first embodiment of the invention 10 is illustrated with tape 12 extended. Tab 11 is affixed to the outer end of tape 12. Tape 12 is extended from the front end of housing 13. A handle 14 is affixed to the rear end of housing 13. A speed control device is attached to the front of housing 13. The speed control device is comprised of Lucite pieces 15 and 16 joined by pin 17 to two more Lucite pieces 18 and 18 joined by a member 17. Pressure of the user's finger presses roller 20 against tape 12 to allow variable control of the rate of speed of the retracting tape 12.

During the course of this description like numerals will be used to identify like elements according to the different figures which illustrate the invention.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A speed control device for a tape measure, said tape measure having a housing defining a chamber and having a peripheral wall with an aperture or opening, a coiled tape connected to a spring at a first end of the tape and wound around a bobbin set in the housing, and a tab attached to a second end of said tape to allow a user to grasp the tape when drawing out the tape through the opening, and positioned on the outside of said housing, immediately above the aperture formed on the lower end of a wall of the housing, the speed control device comprising:
a hinged lever mechanism which allows the user to press a finger on said speed control device, which will then apply pressure on a rubber roller which will make contact with the tape through a second larger opening in said housing, slowing the speed of the tape in direct proportion to the amount of pressure placed on said speed control device.

2. The tape measure with speed control device according to claim 1, wherein a handle is attached to the rear end of the tape measure housing
